(19) United States
(12) Patent Application Publication
(10) Pub. No.: US 2005/0024846 A1
(43) Pub. Date: Feb. 3, 2005

(54) Reflective plate and illumination module with same

(76) Inventors: Ta-Cherng Yu, Tu-chen (TW); Charles Leu, Fremont, CA (US); Ga-Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/903,684

(22) Filed: Jul. 30, 2004

(30) Foreign Application Priority Data
Jul. 30, 2003 (TW) 92120920

(51) Int. Cl. F21V 7/04

(52) U.S. Cl. 362/31

(57) ABSTRACT

The present invention relates to a reflective plate (23) and a backlight system (2) using the same. The reflective plate includes a substrate (232) and a reflective film (233). The reflective plate has a plurality of dots (231) formed thereon to diffuse light beams impinging thereon.

### BACKGROUND OF THE INVENTION

1. Field of the Invention

The invention generally relates to a reflective plate and an associated backlight system used for a liquid crystal display (LCD) device.

2. Prior Art

In general, a monochrome or color LCD has the advantages of thinness, light weight and low power consumption. For this reason, LCDs are widely used in various types of electronic equipment, from pocket calculators to large-scale office automation equipment.

Conventionally, an LCD includes a backlight system 1, as shown in FIG. 4. The backlight system 1 includes a light guide plate 12, a light source 11, a reflective plate 13, two diffusing sheets 14, 16, and a prism sheet 15. The light guide plate 12 includes a light incident surface (not labeled), a light-emitting surface 123, and a bottom surface 122 opposite to the light-emitting surface 123. The diffusing sheet 14, prism sheet 15 and diffusing sheet 16 are located one on the other on the light-emitting surface 123. The light source 11 is arranged adjacent to the light incident surface. The reflective plate 13 is arranged under the bottom surface 122.

Referring to FIG. 5, the reflective plate 13 includes a substrate 132 and an upper reflective film 133. The reflective film 133 has a smooth outer surface (not labeled).

In operation, light beams emit from the light source 11 and enter the light guide plate 12. Part of the light beams emit from the bottom surface 122 of the light guide plate 12, are reflected by the reflective plate 13, and then re-enter the light guide plate 12. Said light beams then emit from the light-emitting surface 123, and successively pass through the diffusing sheet 14, the prism sheet 15 and the diffusing sheet 16.

The two diffusing sheets 14, 16 can increase a uniformity of luminance of the backlight system 1. However, the two diffusing sheets 14, 16 make the backlight system 1 relatively complicated and costly.

### SUMMARY OF THE INVENTION

An object of the present invention is to provide a reflective plate with a diffusing function.

Another object of the present invention is to provide a backlight system with a simple construction and low cost.

A reflective plate in accordance with the present invention comprises a substrate and a plurality of dots formed thereon. The dots diffuse light beams impinging thereon.

A backlight system in accordance with the present invention comprises a light guide plate and a reflective plate. The light guide plate has a light incident surface, an opposite bottom surface, and a light-emitting surface therebetween. The reflective plate is located under the bottom surface of the light guide plate. A plurality of dots is formed on the reflective plate to diffuse light beams impinging thereon and reflect the light beams back to the light guide plate.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic side elevation of a backlight system according to the present invention;

FIG. 2 is an isometric view of a reflective plate of the backlight system of FIG. 1;

FIG. 3 is a light path diagram of part of the backlight system of FIG. 1;

FIG. 4 is a schematic side elevation of a conventional backlight system; and

FIG. 5 is a schematic side elevation of a reflective plate of the backlight system of FIG. 4.

### DESCRIPTION OF THE PREFERRED EMBODIMENTS

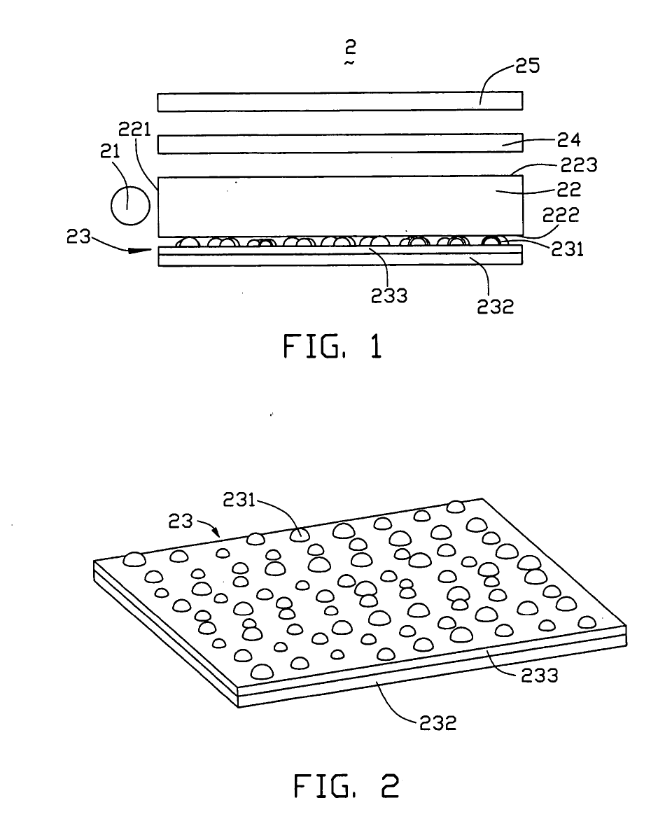

Referring to FIGS. 1 and 2, a backlight system 2 according to a preferred embodiment of the present invention includes a light guide plate 22, a light source 21, a reflective plate 23, a diffusing sheet 24 and a prism sheet 25. The light guide plate 22 has a light-emitting surface 223, an opposite bottom surface 222, and a light incident surface 221 adjoining both the light-emitting surface 223 and the bottom surface 222. The light source 21 is arranged adjacent to the light incident surface 221 of the light guide plate 22. The reflective plate 23 is located under the bottom surface 222 of the light guide plate 22. The diffusing sheet 24 and the prism sheet 25 are successively arranged on the light-emitting surface 223 of the light guide plate 22.

The reflective plate 23 has a substrate 232, and a reflective film 233 formed on the substrate 232. The substrate 232 is made from silver or glass. The reflective film 233 is made from white polyethylene terephthalate, and is opposite to the bottom surface 222 of the light guide plate 22.

A plurality of reflective dots 231 is formed on the reflective film 233. The dots 231 are hemispherical, and have different diameters in the range from 1 to 3 micrometers. The dots 231 cooperatively function as a diffusing sheet to diffuse light beams impinging thereon and reflect the light beams back to the light guide plate 22. A density of distribution of the dots 231 progressively increases with increasing distance away from the light incident surface 221. This assures that the light beams can emit over an entirety of the light-emitting surface 223. A distribution of sizes of the dots 231 may be random. Alternatively, progressively more large dots 231 may be provided with increasing distance away from the light incident surface 221.

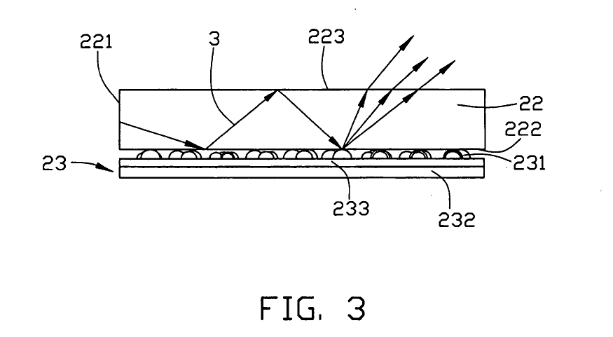

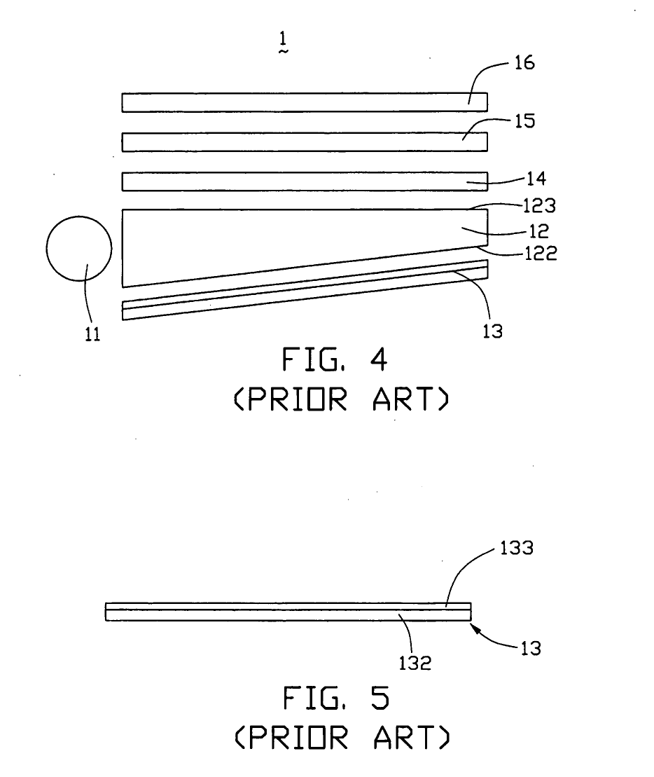

Referring to FIG. 3, in operation, light beams 3 emitted by the light source 21 (not shown) pass through the light incident surface 221 and enter the light guide plate 22. Part of the light beams 3 transmit along the light guide plate 22 and emit from the light-emitting surface 223. The other light beams 3 emit from the bottom surface 222, and part of these light beams are diffused by the dots 231 of the reflective plate 23. The light beams diffused by the dots 231 are thus divided into even more light beams, and reflected back to the light guide plate 22 in different directions. Said light beams then pass through the light guide plate 22 and emit from the light-emitting surface 223 of the light guide plate 22 in different directions. Therefore the light guide plate 22 provides more uniform light.

The reflective plate 23 with the dots 231 formed thereon functions as a diffusing sheet. Therefore the backlight system 2 needs only one diffusing sheet 24 located on the light-emitting surface 223. Thus simply construction and low cost of the backlight system 2 and are both attained.

In a reflective plate in accordance with an alternative embodiment of the present invention, the dots 231 can be substituted by a plurality of reflective concaves. The concaves provide a diffusing function similar to the dots 231 of the reflective plate 23 of the preferred embodiment.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A reflective plate comprising:
a substrate; and
a plurality of dots or concaves formed above the substrate for diffusing light beams impinging thereon.

2. The reflective plate as claimed in claim 1, further comprising a reflective film formed on the substrate, the dots being formed on the reflective film.

3. The reflective plate as claimed in claim 2, wherein the dots are generally hemispherical.

4. The reflective plate as claimed in claim 3, wherein the dots have different in diameters in the range from 1 micrometer to 3 micrometers.

5. The reflective plate as claimed in claim 1, wherein the substrate of the reflective plate is made from silver.

6. The reflective plate as claimed in claim 1, wherein the substrate of the reflective plate is made from glass.

7. The reflective plate as claimed in claim 2, wherein the reflective film is made from white polyethylene terephthalate.

8. A backlight system comprising:
a light guide plate having a light-emitting surface, an opposite bottom surface, and a light incident surface therebetween; and
a reflective plate located under the bottom surface of the light guide plate;
wherein
a plurality of upward curved structures located under the light guide plate but above the reflective plate.

9. The backlight system as claimed in claim 8, wherein said upward curved structures include a plurality of dots formed on the reflective plate for diffusing light beams impinging thereon and reflecting the light beams back to the light guide plate.

10. The backlight system as claimed in claim 9, wherein the reflective plate further comprises a substrate, and a reflective film formed on the substrate and being opposite to the light guide plate, the dots being formed on the reflective film.

11. The backlight system as claimed in claim 9, wherein the dots are generally hemispherical.

12. The backlight system as claimed in claim 9, wherein a density of distribution of the dots progressively increases with increasing distance away from the light incident surface.

13. The backlight system as claimed in claim 10, wherein the reflective film is made from white polyethylene terephthalate.

14. A backlight system comprising:
a light guide plate having a light-emitting surface, an opposite bottom surface, and a light incident surface therebetween; and
a reflective plate located under the bottom surface of the light guide plate;
wherein
wherein a plurality of concaves are formed on the reflective plate for diffusing light beams impinging thereon and reflecting the light beams back to the light guide plate.
